(19) United States
(12) Patent Application Publication
(10) Pub. No.: US 2007/0061429 A1
(43) Pub. Date: Mar. 15, 2007

(54) Optimizing utilization of application resources

(75) Inventor: Tony H. Lin, Mountain View, CA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/224,596

(22) Filed: Sep. 12, 2005

(51) Int. Cl. G06F 15/177

(52) U.S. Cl. 709/220

(57) ABSTRACT

Utilization of a resource by an application can be optimized in response to an optimization event. The event may include an expiration of a timer, a change in an operating condition of the application, a detection of work to be performed by the application, or some other event. Optimizing the application increases the operating efficiency of the application on the client as well as the application itself. Data used to optimize the application on a client may include environmental data, application operation data, and other data. The data may be weighted or considered equally.

### BACKGROUND

### DESCRIPTION OF THE RELATED ART

Computer systems often include several devices and applications competing for one or more resources at a time. As these computer systems become more sophisticated, more devices and applications compete for the same resources. When a computing device implements several applications, the bandwidth for each application is usually reduced and system efficiency is limited by the capability of the device. In other cases, applications distributed over one or more clients may compete for a single resource. In this case, performance of the applications is limited not by the computing device itself, but by the capabilities of the resource in demand.

Typical resource allocation systems allocate resources to a requesting entity based on priority of the requesting entity. These allocation techniques are implemented from the point of view of the resource. For example, some large scale resource allocation systems include an allocation server to allocate resources. These allocation servers can allocate a number of resources for a number of requesting computing devices based on priority of the requesting server.

### SUMMARY

The present technology, roughly described, optimizes utilization of resources by an application. In one embodiment, work processes within the application are optimized to increase the operating efficiency of the application on the client. As a result, client operating efficiency is increased. Factors used to optimize the application on a client include environmental factors and the current configuration of the application.

In one embodiment, upon the occurrence of an optimization event, an optimal configuration for an application is determined. The event may include an expiration of a timer, a change in an operating condition of the application, a detection of work to be performed by the application, or some other event. Depending on the optimization, the current application configuration may be changed to improve application efficiency.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an embodiment of a system for optimizing an application.

FIG. 2 illustrates an embodiment of an application.

FIG. 3 illustrates an embodiment of a computing environment for use with the present technology.

FIG. 4 illustrates an embodiment of a method for optimizing an application.

FIG. 5 illustrates an embodiment of a method for retrieving environmental data.

FIG. 6 illustrates an embodiment of a method for computing operating configurations for an application.

FIG. 7 illustrates an embodiment of a method for computing an operating configuration for an application.

### DETAILED DESCRIPTION

The technology herein optimizes application utilization of a resources. The application is located on a client device. The application is optimized to increase the operating efficiency of the application on the client. The optimized application may be one of several applications on the client. Factors used to optimize the application on a client include environmental factors and the current configuration of the application. Environmental factors and other optimizing details are discussed in more detail below.

Upon the occurrence of an event, an optimal configuration for the application is determined. The event may include an expiration of a timer, a change in an operating condition of the application, a detection of work to be performed by the application, or some other event. Depending on the optimization, the current application configuration may be changed to improve application efficiency. For example, if the optimized configuration provides for more efficient operation of the application and/or client, application configuration may be changed. This is discussed in more detail below.

In one embodiment, the technology described herein may be used in an electronic mail system. In this case, the optimized application may be either a mail client application or, in the case of a web-based mail service, a network browser application. In one embodiment, the mail client application may be implemented as “Entourage” software, by Microsoft Corporation of Redmond, Wash. In other embodiments, the technology described herein can be applied to other applications, including applications other than those associated with email systems.

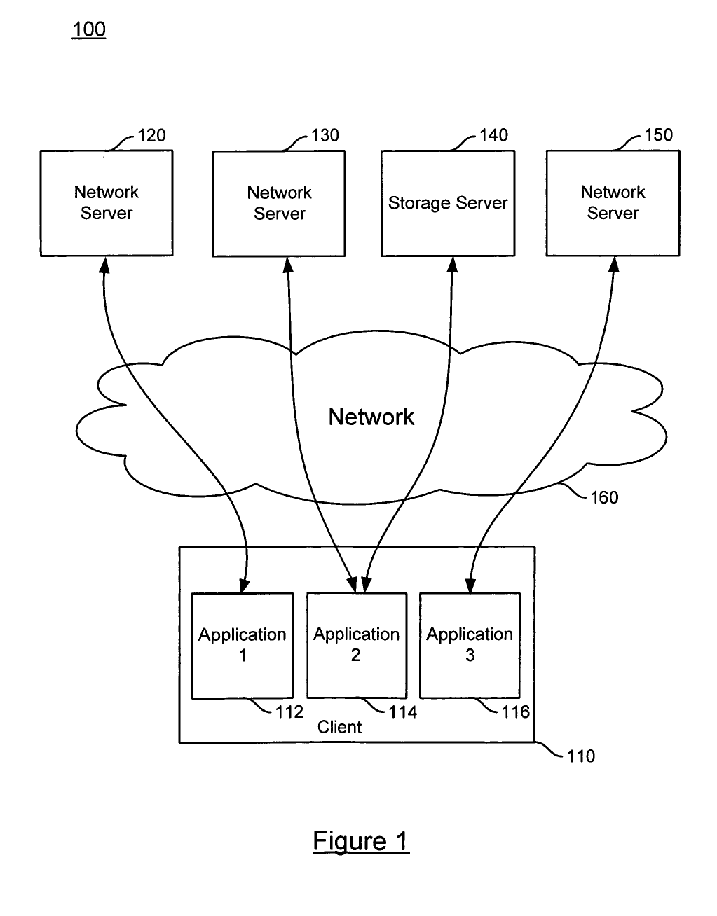

FIG. 1 illustrates an embodiment of a system 100 for optimizing an application. System 100 includes client device 110, network server 120, network server 130, storage server 140 and network server 150. Client device 110 communicates with network servers 120, 130 and 150 and storage server 140 over network 160. In one embodiment, network 160 is implemented as the Internet.

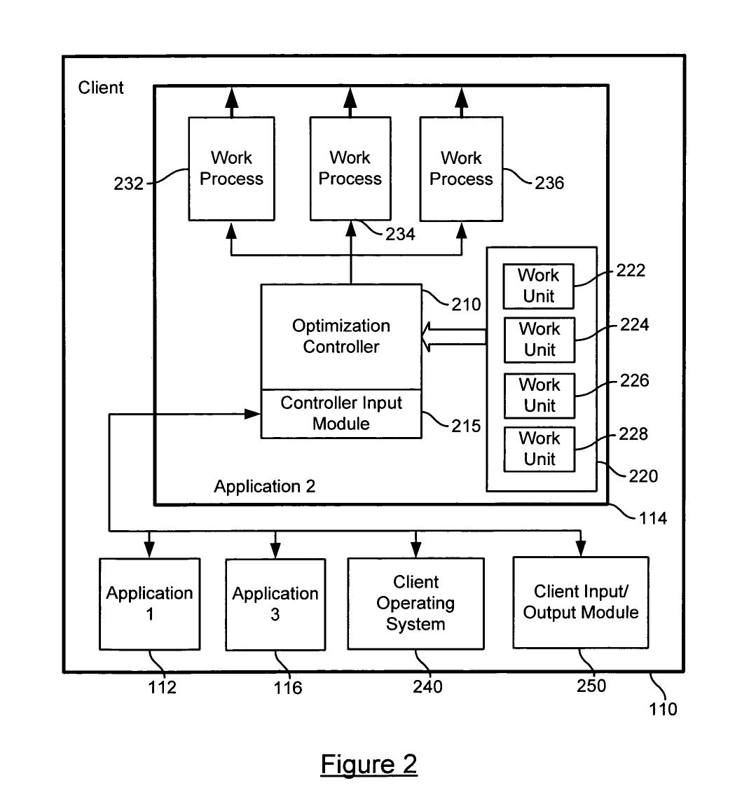

Client device 110 may include one or more applications. In the embodiment illustrated in system 100, client application 110 includes applications 112, 114 and 116. Applications 112-116 within client 110 may communicate with network servers 120-150, respectively. Additionally, application 114 may communicate with storage server 140. Each application within client device 110 has a number of resources, such as work processes and other resources. The present technology optimizes each application such that its resources are used to increase the efficiency of the application. Client device 110 is discussed in more detail below with respect to FIG. 2.

Network servers 120, 130 and 150 may communicate over network 160 with client device 110 or applications within client 110. In one embodiment, network servers 120-150 may be implemented as web servers 112-116. In this case, applications may communicate with the web servers to provide web content to a user. Network servers 120-150 may include information and data used to generate a content page or user interface associated with the network-based mail service.

Storage server 140 may communicate with client device 110 or applications 112-116 within client device 110. In an embodiment wherein system 100 implements a mail service, storage server 140 may store emails and other data associated with users having an account with the mail service.

In one embodiment, application 114 may be implemented as a client-based mail application. As a mail application, application 114 may provide mail service interfaces to a user and retrieve information, including emails, from storage server 140. In another embodiment, application 114 may be implemented as a browser application. In this case, the browser application may provide web page content retrieved from network server 130 (or any other network server) and retrieve emails and other mail service account information from storage server 140.

An application may have one or more types of resources. Resources may include a number of work processes, allocated bandwidth and other elements. FIG. 2 illustrates an embodiment of an application 114 having resources. In one embodiment, client device 110 of FIG. 2 provides more detail of client device 110 of FIG. 1. Client 110 of FIG. 2 includes application 112-116, operating system 240, and input/output (I/O) module 250. Application 114 includes optimization controller 210, controller input module 215, work unit module 220, and work process units 232, 234 and 236. Work unit module 220 may include one or more work units, such as work units 222, 224, 226 and 228. Application 114 may communicate with application 112, application 116, operating system 240 and client input-output module 250.

In one embodiment, application 114 may send and receive data with applications 112 and 116, operating system 240 and I/O module 250 through controller input module 215. Controller input module 215 may receive data with which application 114 can be optimized. The data may include environmental data, application performance data, and other data.

Environmental data may be retrieved from many sources. In one embodiment, environmental data may be retrieved from client operating system 240. Environmental data retrieved from client operating system 240 may include the status of applications within the client display (for example, which application is in the foreground of the client display), the speed and/or type of network connection maintained by the client, the bandwidth currently used by other applications within the client, and other information. In some embodiments, environmental data may also be retrieved through input-output module 250. For example, information may be retrieved regarding the total bandwidth of a resource.

Environmental data may also be retrieved from other applications within the client. Environmental data retrieved by application 114 from application 112 and 116 may include the last time input was received by application 112 or 116, work scheduled to be performed within application 112 or application 116, or other data.

After receiving data through controller input module 215, the environmental data is provided to optimization controller 210 for further processing. Optimization controller 210 operates to process pending work requests and determine optimal operating configurations for application 114. In determining an optimal operating configuration, optimization controller 210 may receive data through controller input module 215. In one embodiment, the data may be associated with operating system 240, applications on client 110 (such as applications 112 and 116), other parts of application 114, a user of the client, and resources outside of the client (such as storage server 140). Data may be received continuously and/or periodically. In one embodiment, the received data is analyzed upon the occurrence of an event, such as the expiration of a period of time, detection of a changed parameter, or some other event. A detection of a changed parameter may include a change in the data input or output rate for the application, connection speed of the client, or some other event.

When generating an optimized configuration for application 114, optimization controller 210 may use a heuristic to determine the optimum amount of work that the application should process. In one embodiment, the configuration may include increasing or decreasing the number of work processes maintained by application 114. In system 200 of FIG. 2, optimization controller 210 currently implements three work processes, work processes 232-236. In some embodiments, more or less work processes may be used. Operation of optimization controller 210 is discussed in more detail below.

Work processes 232-236 are implemented in a similar manner as threads. A processor within client 110 designates processing bandwidth to process work associated with each work process. Additional work processes running within an application allow more work to be handled simultaneously by the application. However, the work processes are limited by the bandwidth designated for the particular application.

Work Unit Module 220 organizes and provides work units for optimization controller 210. In particular, Work Unit Module 220 may set priority levels for work units, provide work units to Optimization Controller 210 based on priority and other factors, and otherwise manage work units to be completed by application 114. I/O Module 250 handles outgoing and incoming data transmission for application 114. Thus, when application 114 sends requests or other data or receives a response or other data from outside application 114, the data is sent or received through I/O Module 250.

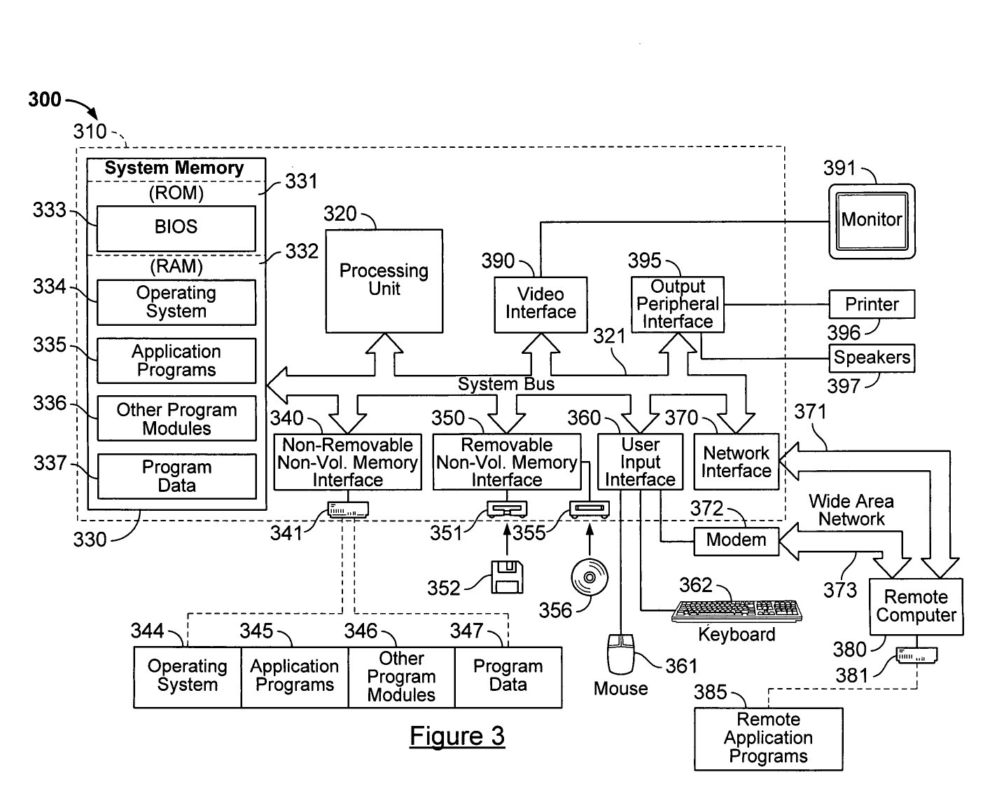

FIG. 3 illustrates an example of a suitable computing system environment 300 on which the present technology may be implemented. In particular, computing system 300 may be used to implement network servers 120, 130 and 150, storage server 140 and client device 110 of FIG. 1. The computing system environment 300 is only one example of a suitable computing environment and is not intended to suggest any limitation as to the scope of use or functionality of the present technology. Neither should the computing environment 300 be interpreted as having any dependency or requirement relating to any one or combination of components illustrated in the exemplary operating environment 300.

The present technology is operational with numerous other general purpose or special purpose computing system environments or configurations. Examples of well known computing systems, environments, and/or configurations that may be suitable for use with the present technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The present technology may be described in the general context of computer-executable instructions, such as program modules, being executed by a computer. Generally, program modules include routines, programs, objects, components, data structures, etc. that perform particular tasks or implement particular abstract data types. The present technology may also be practiced in distributed computing environments where tasks are performed by remote processing devices that are linked through a communications network. In a distributed computing environment, program modules may be located in both local and remote computer storage media including memory storage devices.

With reference to FIG. 3, an exemplary system for implementing the present technology includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 typically includes a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 330 includes computer storage media in the form of volatile and/or nonvolatile memory such as read only memory (ROM) 331 and random access memory (RAM) 332. A basic I/O system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336, and program data 337.

The computer 310 may also include other removable/non-removable, volatile/nonvolatile computer storage media. By way of example only, FIG. 3 illustrates a hard disk drive 340 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3, provide storage of computer readable instructions, data structures, program modules and other data for the computer 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 30 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through an output peripheral interface 390.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 3 illustrates remote application programs 385 as residing on memory device 381. It will be appreciated that the network connections shown are exemplary and other means of establishing a communications link between the computers may be used.

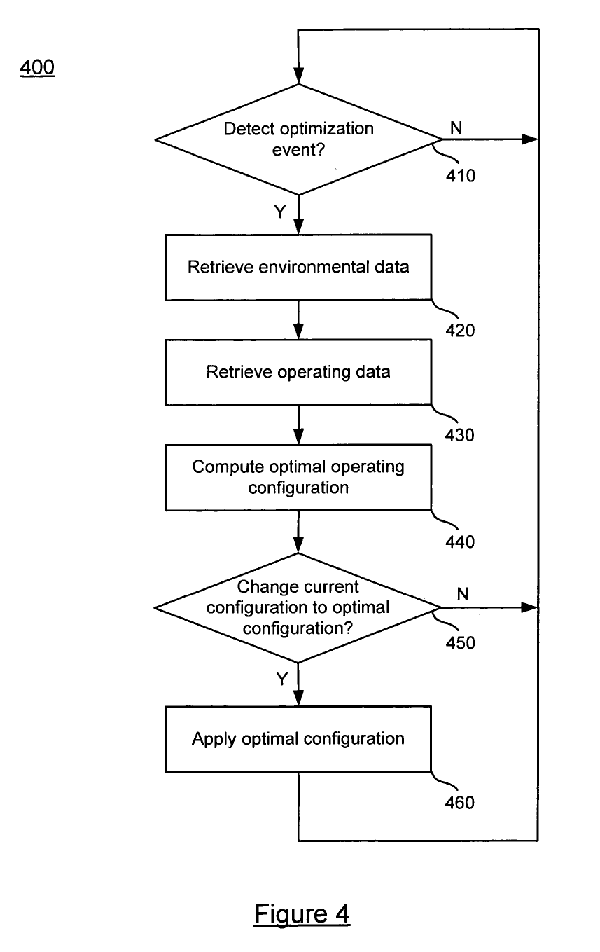

As discussed above, optimization controller 210 may determine an optimal operating configuration for an application. Once determined, the current operating configuration can be replaced or remain. In one embodiment, the current operating configuration may remain if it achieves a similar efficiency to that of the optimal operating configuration. FIG. 4 illustrates an embodiment of a method 400 for optimizing application resources. For purposes of illustration, method 400 will be discussed with respect to application 114 of FIG. 1.

A determination is made as to whether an optimization event has been detected at step 410. As discussed above, an optimization event may include the expiration of a period of time or the occurrence of some other event, such as detection of work to be performed within application 114. In one embodiment, application 114 has work to perform if work unit module 220 has work units (such as work units 222-228) waiting to be processed by optimization controller 210. If an optimization event is detected, operation continues to step 420. If an optimization event is not detected, operation remains at step 410 until such an event is detected.

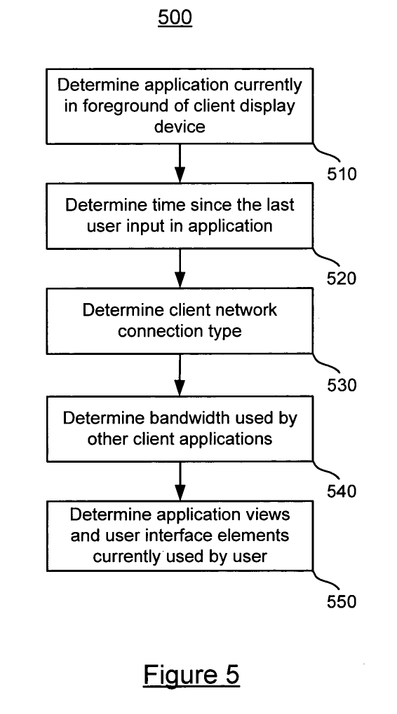

Environmental data is retrieved at step 420. As discussed above, environmental data may include data regarding other applications within a client, the client operating system, the client input-output module, and data within application 114 itself. Retrieving environmental data at step 420 is discussed in more detail below with respect to method 500 of FIG. 5.

Operating data of the application is retrieved at step 430. Operating data of the application can include performance and other information regarding application 114 of client device 110. In one embodiment, operating data can include the data transfer rate for the application. For example, application 114 may have a data transfer rate of 100 Kbytes/second. In this case, when application 114 is implementing a browser application providing a network mail service interface, work processes 232-236 may retrieve folder information, user mail, and other content associated with the user's account at a rate of 100 Kbytes per second.

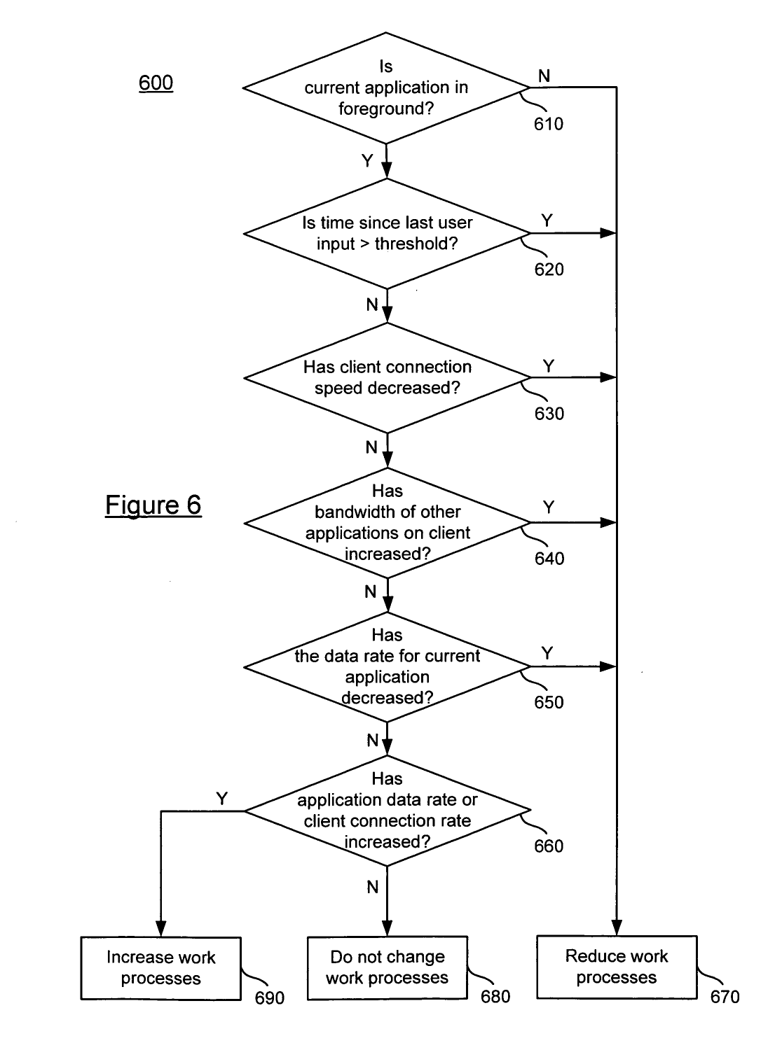

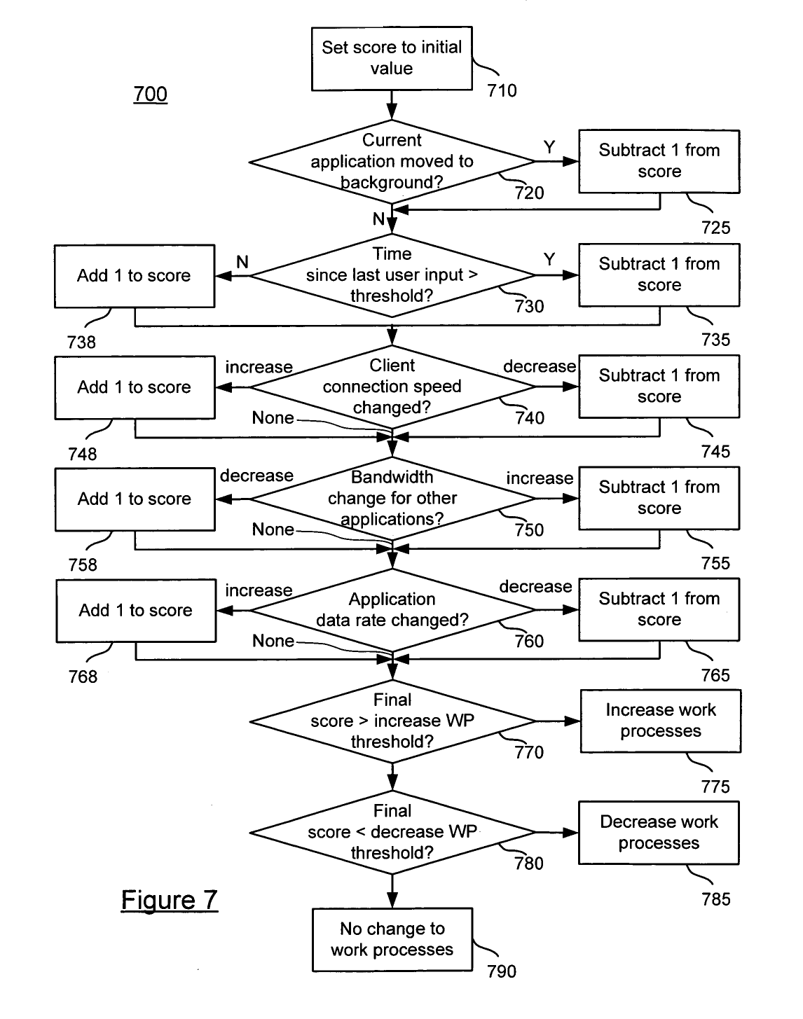

An optimal operating configuration is computed for application 114 at step 440. The optimal operating configuration is computed based on several factors. These factors may include the retrieved environmental data, operating data, and other data. An embodiment of a method for computing an optimal operating configuration for application 114 is discussed in more detail below with respect to method 600 of FIG. 6. Another embodiment of a method for computing an optimal operating configuration (utilizing a weighting scheme) is discussed below with reference to method 700 of FIG. 7.

Next, a determination is made as to whether the current operating configuration should be changed at step 450. In one embodiment, the current operating configuration should be changed if the current operating configuration is less efficient than the optimal operating configuration determined at step 440. For example, if a current operating configuration involves three work processes (as illustrated in application 114 of system 200 of FIG. 2), and the optimal operating configuration computed at step 440 utilizes four work processes, the operating configuration can be changed from three to four running work processes. If no change should be made to the operating configuration at step 450, operation continues to step 410. If a change should be made to the current operating configuration, then the new configuration is applied at step 460. Operation then continues to step 410.

The optimal operating configuration is determined at least in part on retrieved environmental data. FIG. 5 illustrates an embodiment of a method 500 for retrieving environmental data. In one embodiment, method 500 provides more detail for step 420 of method 400 discussed above. Method 500 can be performed by optimization controller 210 of application 114 within system 200. First, the application currently displayed in the foreground of a client display device, is determined at step 510. In one embodiment, several applications may currently be running on the client device. Each application may be associated with a user interface (or window) that the client operation system displays on the client display device. In one embodiment, optimization controller 210 may request this information from operating system 240. The user interface or window currently in the foreground corresponds to the application which a user may currently be working with. Thus, the application currently being used by a user may be designated more bandwidth

Next, the time since the last user input was received by application 114 is determined at step 520. In one embodiment, as application 114 receives user input, application 114 records a time stamp associated with the time the input was received. Application 114 may then store the time stamp information to indicate when the input was received. Thus, optimization controller 210 may retrieve this information from application 114. In another embodiment, optimization controller 210 may query other applications within client 110 to determine the last time user input was received by each application. In this embodiment, optimization controller 210 may determine if a user is actively using another application.

The connection type (or connection speed) used by client device 110 is determined at step 530. Client 110 may be capable of several types of connections. These connections may include dialup, DSL, T1, or some other connection type. In some cases, client device 110 will include networking hardware and/or software (not illustrated in FIGS. 1-2) that handles the client device connection and communicates with operating system 240. Optimization controller 210 may query operating system 240 to determine the connection information. The bandwidth used by each application running on client device 110 is then determined at step 540. Optimization controller 210 may request the bandwidth information for each running application from operating system 240.

Application views and user interface elements currently used by the user for application 114 are determined at step 550. Since application views and user interface elements are managed by the application providing the user interface or view, optimization controller 210 retrieves this information from within application 114. For example, application 114 may be implemented as a browser application or mail client application which provides a user interface for a mail service. In this case, a determination may be made at step 550 that a user is currently viewing a mail inbox interface. This information can be used to prioritize requests for interface pages and other content. All the data retrieved in steps 510-550 may be used to configure an optimization configuration for application 114. This is discussed in more detail below.

Once the environmental data and application operating data has been retrieved, an optimal operating configuration can be determined. FIG. 6 illustrates an embodiment of a method 600 for computing an optimal operating configuration for application 114. In one embodiment, method 600 provides more detail for step 440 of method 400 discussed above. First, a determination is made as to whether the current application was determined to be in the foreground at step 610. This determination relates to step 510 of method 500 where the foreground application was determined. If the current application is in the foreground of the client device display, operation continues to step 620. If the current application was determined not to be in the foreground, then operation continues to step 670. At step 670, the number of work processes maintained by the application is reduced. The number by which to reduce the work processes at step 670 may depend on the data being considered as well as the total number of work processes. In one embodiment, the number of work processes is reduced the greater of one work process or ten percent of the current running work processes at step 670.

A determination is made as to whether the time since the last user input received in an application is greater than a threshold value at step 620. Thus, a comparison is made from the time retrieved at step 520 of method 500 to a threshold value. The threshold value may be a time period representing a reasonable time during which user input can or should be received. If the time since the last user input was received in the application is greater than the threshold, operation continues to step 670 where work processes are reduced. If the time since the last user input received in the application is not greater than the threshold, operation continues to step 630.

A determination is made as to whether the client device 110 connection speed has decreased at step 630. This determination can be made by comparing the speed determined at step 530 of method 500 and the client connection speed at some earlier point in time. In one embodiment, a client's connection speed to a resource, such as storage server 140 or a network server 130, can decrease if a connection means associated with the client has failed. If a client connection speed has decreased at step 530 of method 500, operation continues to step 670. If the client connection speed has not decreased, operation continues to step 640. A determination is made at step 640 as to whether the bandwidth of other applications residing on the client has increased. This determination can be made from the data retrieved at step 540 of method 500. If the bandwidth of other applications has increased, then operation continues to step 670. In this case, the bandwidth of the current application should be decreased in order to properly provide bandwidth to other applications which need additional bandwidth. If the bandwidth of the other applications has not increased, then operation continues to step 650.

A determination is made as to whether the data rate for the application has decreased at step 650. This determination can be made from the operation data retrieved at step 430 of method 400 discussed above and operational data retrieved at an earlier time interval. If the data rate for the application has decreased since the last time interval or configuration optimization, then a previous configuration optimization may not have resulted in a more beneficial configuration. In particular, the previous configuration optimization may have reduced the data rate for the application. In some embodiments, the data rate may be reduced for other reasons. If the data rate for the application has decreased, operation continues from step 650 to step 670. If the data rate for an application has not decreased, then operation continues to step 660.

A determination is made as to whether the data rate for the application or the connection speed of the client has increased at step 660. If either the data rate for the application or the connection speed for the client has increased, operation continues to step 690 where a work process is added for the application. In this case, either the application has been performing in a positive manner or the client device has obtained more bandwidth through a connection speed increase. In either case, the heuristics model can add one or more additional work processes in an attempt to determine an optimal configuration for the application. Operation of the application can then be re-evaluated at the occurrence of the next optimization event. If neither the data rate nor the connection speed has increased at step 660, operation continues to step 680 where no change is made to the optimization configuration model.

In one embodiment, a method for computing an optimal operating configuration for application 114 may utilize a weighting or scoring scheme for data used to generate the configuration. FIG. 7 illustrates an embodiment of a method 700 for computing an operating configuration for an application. Method 700 utilizes a scoring technique to determine whether an optimization configuration should be changed. In one embodiment, method 700 provides more detail for step 440 of method 400 discussed above.

First, an score is set to an initial value at step 710. In one embodiment, the initial value may be any value as long as ranges can be identified for increasing, decreasing or keeping the number of work processes the same. Next, a determination is made as to whether the current application has been moved to the background at step 720. In this case, the determination involves whether the current application was previously in the foreground at the time of the last optimization configuration, but has since been moved to the background. If the current application has been moved to the background at step 720, operation continues to step 725. A value of one is subtracted from the score initial value at step 725. In one embodiment, some other number may be subtracted from the initial score. In some cases, different values may be subtracted or added to the score depending on the weight that should be associated with the particular factor considered, though other values can be used. For purposes of illustration, the embodiment illustrated in method 500 will add and subtract values of one for each factor considered. After a value of one is subtracted at step 725, operation continues to step 730. If the current application has not been moved to the background at step 720, this indicates the current application is still maintained in the foreground and operation continues to step 730.

A determination is made at 730 as to whether the time since the last user input was received in the current application (or the application currently in the foreground) is greater than a threshold value. This determination is similar to the determination made at step 620 of method 600. If the time since the last user input is greater than a threshold value, operation continues to step 735 where a value of one is subtracted from the initial score. Operation then continues to step 740. If the time since the last user input has not exceeded a threshold, then operation continues to step 738 where a value of one is added to the score. Operation then continues to step 740.

A determination is made as to whether there has been a change in the client's connection speed at step 740. This determination is similar to that of step 630 of method 600. If the client connection speed has decreased, operation continues to step 745 where a value of one is subtracted from the score. Operation then continues to step 750. If the client connection speed has increased, a value of one is added to the score and operation continues to step 750. If no significant change has been detected in the client connection speed, operation continues to step 750 without any change to the score.

A determination is made as to whether the bandwidth in other applications has changed at step 750. The determination made at step 750 is similar to that made at step 640 of method 600. If the bandwidth used by other applications has increased, then operation continues to step 755 where a value of one is subtracted from the score. Operation then continues to step 760. If the bandwidth in other applications has decreased, then operation continues to step 758 where a value of one is decreased from the score. Operation then continues to step 760. If no significant change in bandwidth is detected in other applications residing on client device 110, operation continues to step 760 without adjusting the score.

A determination is made as to whether an application's data rate has changed at step 760. This determination is similar to that made at step 650 of method 600. If an application's data rate has increased, operation continues to step 768 where a value of one is added to the initial score. Operation then continues to step 770. If there is no significant change in the application data rate, operation continues to step 770 without adjusting the initial score. If the data rate for application 114 has decreased, a value of one is subtracted from the score at step 765 and operation continues to step 770.

After adjusting the score based on environmental factors and other factors, the final value of the score is compared to a series of thresholds to determine whether or not work processes should be added, subtracted or maintained within application 114. A determination is made at step 770 as to whether the final value of the score is greater than an Increase Work Processes threshold. If the final score is greater than the Increase Work Processes threshold, operation continues to step 775 where work processes are added within the application. If the final score is not greater than the Increase Work Processes threshold, a determination is made as to whether the final score is less than a Decrease Work Processes threshold at step 780. If the final score is less than a Decrease Work Processes threshold at step 780, work processes are removed from the total number of work processes at step 785. If the final score is not less than the Decrease Work Processes threshold, the score has not significantly changed from the initial score and no change is made in the optimization configuration at step 790.

The score thresholds can be determined in many ways. In one embodiment, the thresholds may be set by an administrator. In another embodiment, the thresholds may be set by a user. In some embodiments, the thresholds can be set so that the processing power required to change to the new number of work processes is less than the processing power gained from making the change. The processing power gained from making the change in work processes may be determined (or estimated) over the period of time between optimization events.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

I claim:

1. A method for optimizing an application, comprising:
retrieving environmental data by a first application, the environmental data is associated with a computing device on which the first application is running;
computing an optimal operating configuration for the first application from the environmental data; and
applying the optimal operating configuration to the first application.

2. The method of claim 1, wherein said step of retrieving environmental data includes:
retrieving data from a second application, the second application located on the computing device.

3. The method of claim 1, wherein said step of retrieving environmental data includes:
determining one of several applications currently in use by a user, the several applications including the first application.

4. The method of claim 1, further comprising:
retrieving application processing rate data from the first application.

5. The method of claim 1, wherein said step of computing an optimal operating configuration includes:
determining whether the fist application is currently in use by a user.

6. The method of claim 1, wherein said step of computing an optimal operating configuration includes:
determining whether the processing bandwidth used by other applications has increased.

7. The method of claim 1, wherein said step of computing an optimal operating configuration includes:
deriving a score from one or more sources of environmental data; and
comparing the score to one or more threshold values.

8. The method of claim 7, wherein said step of deriving the score includes:
weighting the environmental data to derive the score.

9. The method of claim 1, wherein said step of applying the optimal operating configuration includes:
changing the number of running work processes within the first application.

10. The method of claim 1, wherein the first application is a mail client application.

11. An apparatus for optimizing an application, comprising:
a processor;
a memory device in communication with said processor; and
a communication interface in communication with said processor, said processor able to determine an optimized configuration for a first application on a computing device and manage the status of one or more work processes to implement the optimized configuration, the optimized configuration determined from environmental data received by said processor.

12. The system of claim 11, wherein the communication interface is able to receive environmental data from one or more applications on the computing device and provide the environmental data to said processor, the one or more applications including the first application.

13. The system of claim 11, wherein said one or more work processes are included within the first application.

14. The system of claim 11, wherein the environmental data is retrieved from an operating system associated with the computing device.

15. One or more processor readable storage devices having processor readable code embodied on said processor readable storage devices, said processor readable code for programming one or more processors to perform a method comprising:
detecting an optimization event;
determining an optimal configuration for an application in response to the optimization event, the optimal configuration derived from environmental data; and
optimizing the application in response to determining the optimal configuration.

16. The one or more processor readable storage devices according to claim 15, wherein the optimization event includes detecting a work unit to be performed by the application.

17. The one or more processor readable storage devices according to claim 15, wherein the optimal configuration is determined by the application.

18. The one or more processor readable storage devices according to claim 15, further comprising:
receiving environmental data associated with a computing device, the application running on the computing device.

19. The one or more processor readable storage devices according to claim 15, wherein said step of optimizing the application includes:
determining the optimal configuration for the application is more efficient than the current configuration.

20. One or more processor readable storage devices according to claim 30, wherein said step of optimizing the application includes:
changing the status of one or more work processes managed by the application.
